(19) United States
(12) Patent Application Publication
(10) Pub. No.: US 2007/0022042 A1
(43) Pub. Date: Jan. 25, 2007

(54) REAL-TIME INTERNET AUCTION SYSTEM

(76) Inventor: Junichiro Nishi, Kobe (JP)

Correspondence Address: KLEIN, O'NEILL & SINGH, LLP, 43 CORPORATE PARK, SUITE 204, IRVINE, CA, 92606, US

(21) Appl. No.: 11/458,591

(22) Filed: Jul. 19, 2006

Related U.S. Application Data
(63) Continuation of application No. 09/809,583, filed on Mar. 15, 2001, now abandoned.

(30) Foreign Application Priority Data
Mar. 15, 2000 (JP) 2000-072260

(51) Int. Cl. G06Q 40/00

(52) U.S. Cl. 705/37

(57) ABSTRACT

A real-time auction system that is the same as traditional auctions by utilizing the internet. The system utilizes computers in which a number of buyers bid a price for an article and the bids are transmitted over the internet from the buyers' computers to a computer for an organizer, an assessor, a center and each buyer. If there is more than one bid equal to of above the reserve price set by the assessor, the process repeats until there is only one bid left. The one bid left the successful bidder. When there are no bids above the reserve price set, the process repeats a predetermined number of times.

### CROSS-REFERENCE TO RELATED APPLICATION

This application is a continuation application of co-pending application U.S. Ser. No. 09/809,583, filed on Mar. 15, 2001, entitled Real-Time Internet Auction System.

### BACKGROUND OF THE INVENTION

1. Field of the Invention

This invention relates to an Internet-based auction system and an auction system that can provide all participants with real-time functionality as they have in traditional live auctions.

2. Description of the Related Art

There are auction systems developed and in use, where auction buyers connect to computer systems that auction organizers operate for auctions via various means of communication and carry out auctions.

Japanese Laid-open Patent Publication Hei 11-328,271 defines an auction system where buyers can participate in the auctions with terminal equipment such as a personal computer without going to auction hall. Moreover, remote-buyers can participate in more than one auction optionally since communication control units (which is a part of a communication circuit) send and receive auction data to/from more than one auction hall.

Usually, a conventional remote auction system, which consists of communication lines, main computers and personal computers, sets bid terms to be from an hour to several days. Within these bid terms, remote buyers enter their bid prices via equipment such as personal computers. The successful bidder is the one who enters the highest bid price within the bid term.

The following general problems are pointed out in the auction systems mentioned above.

1) Most bidders bid in the last minutes. These bidders tend to observe the situation at the beginning and bid the price based on the observation just before the auction closes. In this case, it is important to bid as late as possible. This situation does not happen in non-remote (traditional) auctions.

2) In most cases, sellers cannot change their reserve prices that they set in advance. When bid prices are much higher than the reserve price, sellers can lose opportunities to sell items at higher prices.

### SUMMARY OF THE INVENTION

Therefore, an object of the invention is to enable all the participants including an assessor, a seller, and an organizer to conduct and participate in auctions with real-time nature on the Internet just as they do in traditional auctions.

According to a first aspect of the present invention, this object is achieved by a real-time auction system comprising:
a first computer operated by an auction organizer;

a second computer operated by an assessor who exhibits and sells articles;

a plurality of third computers operated by buyers;

a fourth computer in a center for processing;

all of the computers being connected to an online system for receiving and sending data on an auction;

the auction being performed under the control of the fourth computer as follows:

step 1: the buyers bid a price for an article during a first predetermined time period, with the bid information being transmitted to the first computer;

step 2: status of bidding on the article is transmitted to all of the computers over the online system;

step 3: the organizer, the assessor and the buyers confirm the bidding status during a second predetermined time period;

step 4: If the fourth computer determines that there is more than one bid above a reserve price for the article set by the assessor, the fourth computer controls step 1, step 2 and step 3 to be repeated a predetermined number of times until the fourth computer determines that there is one bid left; the one bid being the successful bidder.

According to a second aspect of the present invention, the above object is achieved by a real-time auction system having a center system and bidder equipment of bidders that are formed of computers interconnected via internet,

wherein the center system compares a reserve price of an article for auction stored in a predetermined storage unit with one or more of bid prices input and sent from input unit of the bidder equipment so as to determine a winning bidder such that if a single bid price is equal to or higher than the reserve price, the center system determines the bidder of the single bid price as a winning bidder, while if multiple bid prices are equal to or higher than the reserve price, the center system determines the bidder of the highest one of the bid prices as a winning bidder,

wherein the center system stores in the storage unit: a starting price indicating an initial bidding price; a ceiling price indicating an upper limit of bid price to be input by the input unit of the bidder equipment; and the reserve price of the article,

wherein the center system further stores in the storage unit: a first predetermined period of a cycle of auction from a starting point to an end point of the cycle; and a second predetermined period corresponding to a bidding period, which is shorter than the first predetermined period, and

wherein the center system performs:

a cycle starting step for starting and continuously counting a cycle with the first predetermined period including the bidding period;

a first determining step for determining whether or not bid price data, which is transmitted from the bidder equipment and temporarily stored in the storage unit, and which is transmitted between a starting point of the bidding period to an end point of the second predetermined period, contains price data between the starting price and the ceiling price, in which the center system relates a set of the starting price and the ceiling price for an immediately preceding bidding period to the immediately preceding bidding period, and stores the correlated starting price, ceiling price and immediately preceding bidding period in the storage unit;

a second determining step for determining whether or not at least one of the bid price data is equal to or higher than the reserve price if the center system determines, in the first determining step, that the bid price data contains price data between the starting price and the ceiling price;

a third determining step for determining whether or not the bid price data contains a single bid price equal to or higher than the reserve price in the immediately preceding bidding period if the center system determines, in the first determining step, that the bid price data contains price data between the starting price and the ceiling price, and further determines, in the second determining step, that at least one of the bid price data is equal to or higher than the reserve price;

a first repeating step (i) for determining the highest one of the transmitted bid price data to be a next starting price for a next cycle, and storing the next starting price in the storage unit, and further re-performing the cycle starting step, the first determining step, the second determining step and the third determining step after the end of the first predetermined period, and (ii) for repeating the re-performance until the center system determines a winning bidder, if the center system (a) determines, in the first determining step, that the bid price data contains price data between the starting price and the ceiling price, and (b1) determines, in the second determining step, that each of the bid price data is lower than the reserve price, or (b2a) determines, in the second determining step, that at least one of the bid price data is equal to or higher than the reserve price, and (b2b) determines, in the third determining step, that the bid price data contains multiple bid prices equal to or higher than the reserve price in the immediately preceding bidding period; and

a first winning determination step (i) for determining the bidder of the bid price equal to or higher than the reserve price to be a winning bidder by providing data of the winning bidder with winning bidder data, if the center system (a) determines, in the first determining step, that the bid price data contains price data between the starting price and the ceiling price, and (b2a) determines, in the second determining step, that at least one of the bid price data is equal to or higher than the reserve price, and (b2c) further determines, in the third determining step, that the bid price data contains a single bid price equal to or higher than the reserve price in the immediately preceding bidding period.

According to a third aspect of the present invention, the above object is achieved by a real-time auction system having a center system and bidder equipment of bidders that are formed of computers interconnected via internet, wherein the center system stores in the storage unit: a starting price indicating an initial bidding price; a ceiling price indicating an upper limit of bid price to be input by the input unit of the bidder equipment; and a reserve price of an article for auction,

wherein the center system further stores in the storage unit: a first predetermined period of a cycle of auction from a starting point to an end point of the cycle; and a second predetermined period corresponding to a bidding period, which is shorter than the first predetermined period,

wherein the bidder equipment comprises a bid button for entering a bid price between the starting price and the ceiling price related to a bidding period starting from a starting point of the bidding period after the bidder equipment receives, from the center system, data of the starting point of the bidding period, data of the second predetermined period, data of the starting price and data of the ceiling price, in which the bidder equipment performs a second bidding transmission step for transmitting the bid price entered by the bid button to the center system, and

wherein the center system performs:

a transmission causing step for causing the bidder equipment to transmit the bid price entered by the bid button to the center system;

a cycle starting step for starting and continuously counting a cycle with the first predetermined period including the bidding period;

a seventh determining step for determining whether or not the center system has received a bid price or prices from the bidder equipment in the bidding period;

an eighth determining step for determining whether or not the bid price data contains a single bid price equal to or higher than the reserve price in the immediately preceding bidding period if the center system determines that at least one of the bid price data transmitted from the bidder equipment is equal to or higher than the reserve price stored in the storage unit;

a third winning determination step (i) for determining the bidder of the bid price equal to or higher than the reserve price to be a winning bidder, if the center system determines that at least one of the bid price data transmitted from the bidder equipment is equal to or higher than the reserve price stored in the storage unit, and further determines, in the eighth determining step, that the bid price data contains a single bid price equal to or higher than the reserve price in the immediately preceding bidding period; and

a fourth repeating step (i) for determining the highest one of the bid price data transmitted from the bidder equipment in the bidding period to be a next starting price for a next cycle, and storing the next starting price in the storage unit, and further re-performing the cycle starting step, the transmission causing step, the seventh determining step and the eighth determining step, and (ii) for repeating the re-performance until the center system determines a winning bidder, if the center system (a) determines that each of the bid price data transmitted from the bidder equipment is lower than the reserve price stored in the storage unit, or (b1) determines that at least one of the bid price data transmitted from the bidder equipment is equal to or higher than the reserve price stored in the storage unit, and (b2) determines, in the eighth determining step, that the bid price data contains multiple bid prices equal to or higher than the reserve price in the immediately preceding bidding period.

According to the present invention, all participants including an organizer, assessors, sellers and buyers can conduct and participate in auctions with real-time nature on the Internet just as they do in traditional auctions and they continue each auction until there is only one bidder left. Many articles can be traded in a short time because a session for one article can be completed in a very short time, such as a few tens of seconds to a few minutes, based on the auction system of the present invention. Furthermore, participant s (buyers, assessors and sellers) can deal at more than one lane at the same time, since the center system can process multiple lanes.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic block diagram showing a system structure of an embodiment of a real-time Internet auction system in this invention;

FIG. 2 is a work flow chart of the Internet auction system

FIG. 3 is a chart showing segments of flow by the auction system consisting of multiple lanes

FIG. 4 is a flow chart showing cycles in a session in a corner in a lane

FIG. 5 is a schematic view of a screen of a buyer equipment in a bidding period

FIG. 6(1) is a schematic view of an input area of the buyer equipment in the bidding period, while FIG. 6(2) is a schematic view showing an input area on the screen of both the organizer equipment and the assessor equipment during a bidding status notification period and a trade determination period;

FIG. 7 is a schematic bar graph with multiple bars corresponding to multiple bid prices showing progress of a time indicator and a bid price indicator on the input area of the buyer equipment;

FIG. 8 is a flow chart showing an example of a flow of a determination logic of a cycle winner;

FIG. 9 is a flow chart of a determination process which the auction system performs in a dealing result notification period;

FIG. 10 is an example of a logic flow of a proxy bid price determination and determination of the highest bid price in a cycle in the bidding period that are determined by the auction system; and

FIG. 11 is a chart showing a concept of maximum number of allowed cycles for reserve price modification.

### DESCRIPTION OF THE PREFERRED EMBODIMENTS

Embodiments of the present invention, as best mode for carrying out the invention, will be described hereinafter with reference to the drawings. It is to be understood that the embodiments described herein are not intended as limiting, or encompassing the entire scope of, the present invention. Note that like parts are designated by like reference numerals or characters throughout the drawings.

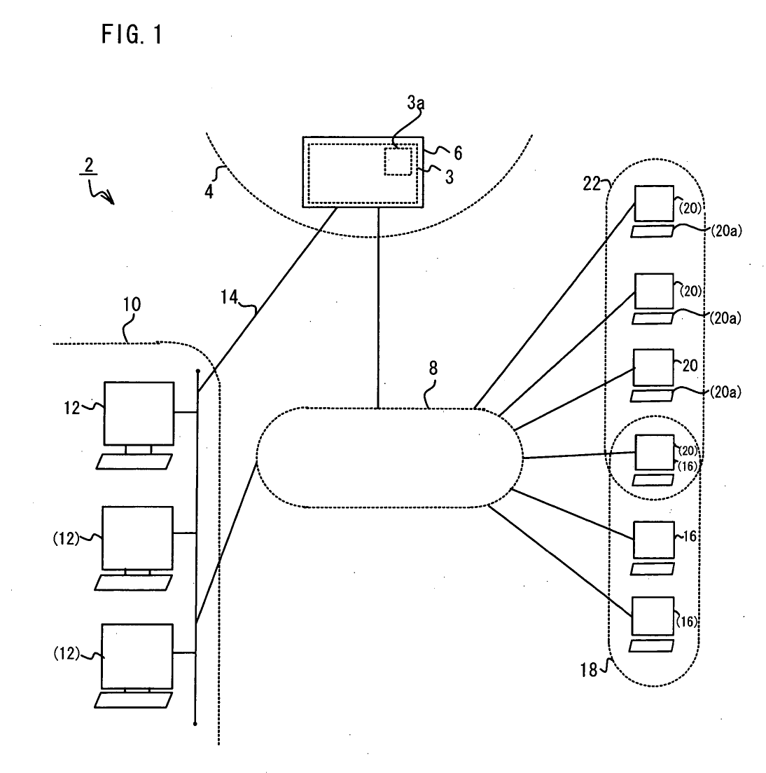

FIG. 1 shows the system structure of the Internet auction system 2 in this invention. An auction center equipment 6 is placed in an auction center 4 having a center system 3 (claimed “fourth computer”) which serves as a main system in the internet auction system 2. The auction center equipment 6 (center system 3) is connected to the Internet 8. Computers 12 each operated by an organizer (organizer equipment corresponding to claimed “first computer”) are placed in an organizer office 10. However, the structure does not need to be limited to the one shown in the figure. For instance, the organizer equipment 12 can be stand-alone. The organizer equipment is connected to the Internet 8. The organizer equipment 12 are connected to the auction center equipment 6 via an independent communication line 14 (that does not pass the Internet 8) for certain tasks.

The center system 3 has a storage unit (memory and/or buffer) 3a for storing (or temporarily storing) various data and operation programs for performing various operations as will be described later. The various data include reserve price data, time length data and bid price data, while the various operation programs include programs for performing various determinations and comparisons as well as data programs for providing various data as will be described later. Although the storage unit 3a (its function) is described herein to be provided in the center system 3, it can be provided in another system such as the organizer equipment 12 entirely or partially. Furthermore, for high speed operation, it is preferable to provide a part of the function of the storage unit 3a by a buffer (input buffer) for temporary storage. For example, the bid price data sent from the buyer equipment 20 is preferred to be temporarily stored in an buffer.

Each of assessors of auction communicates auction data to the auction center equipment 6 and the organizer equipment 12 via the Internet by using its equipment 16 such as a personal computer (assessor equipment corresponding to claimed “second computer”). Each of the assessors can have an auction seller (this is not shown in the figure) to sell articles. The auction sellers communicate to their assessors via e.g. a phone and the Internet. Information of sellers needs to be provided at (input in/output from) the assessor equipment 16. The number of auction assessors is usually more than one (assessors 18).

Buyers' (participants' auction data are exchanged with the auction center equipment 6 and the organizer equipment 12 via the Internet by using their equipment 20 such as personal computers (buyer equipment or bidder equipment corresponding to claimed “third computers”). The buyers' equipment 20 and the assessors' equipment 16 are connected to the Internet 8 and the auction center equipment 6. Data submitted at or input to the buyer equipment (bidder equipment) 20 is appropriately processed and sent to and shown on the assessor equipment 16. Data submitted at or input to the assessor equipment 16 is sent to and shown on the buyer equipment 20. Data is transmitted and processed in the same way between the organizer equipment 12 and the assessor equipment 16, and between the organizer equipment 12 and the buyer equipment 20. Usually the number of buyers is more than one (the buyers 22) and buyers can be assessors at the same time.

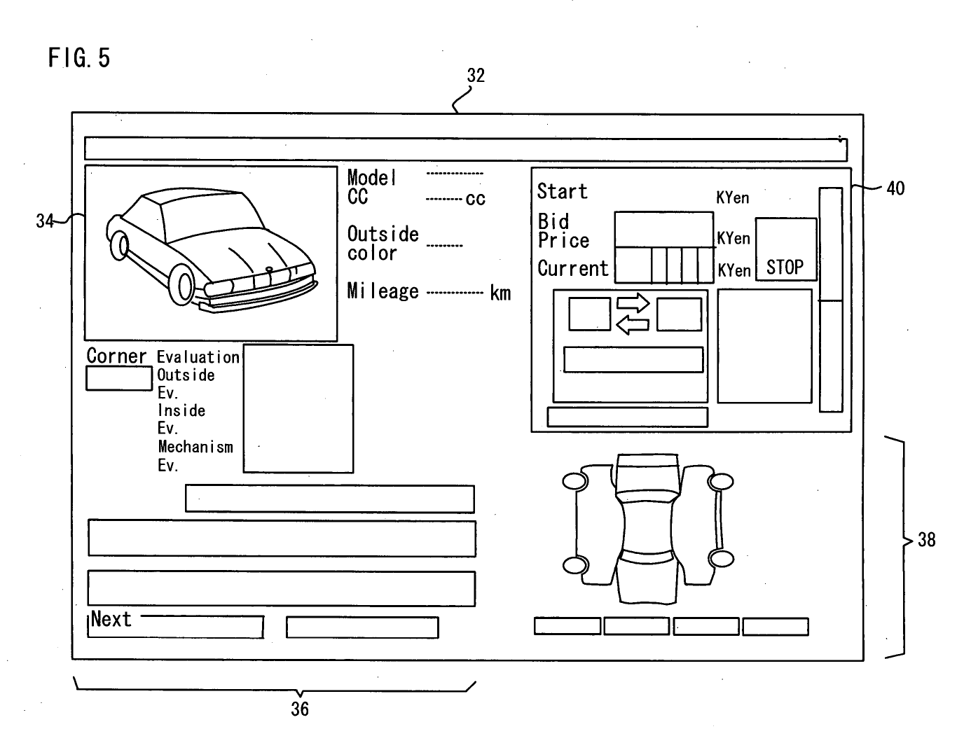

For each buyer to input bid price information or other data, each buyer equipment 20 has an input unit (keyboard and/or mouse) 20a and an input area (input display area) 40 with a buyer's bid button 46 on a screen 32 thereof as will also be described with reference to e.g. FIG. 5. Thus, the input unit 20a and/or the input area 40 correspond to the claimed “input means” of the buyer equipment.

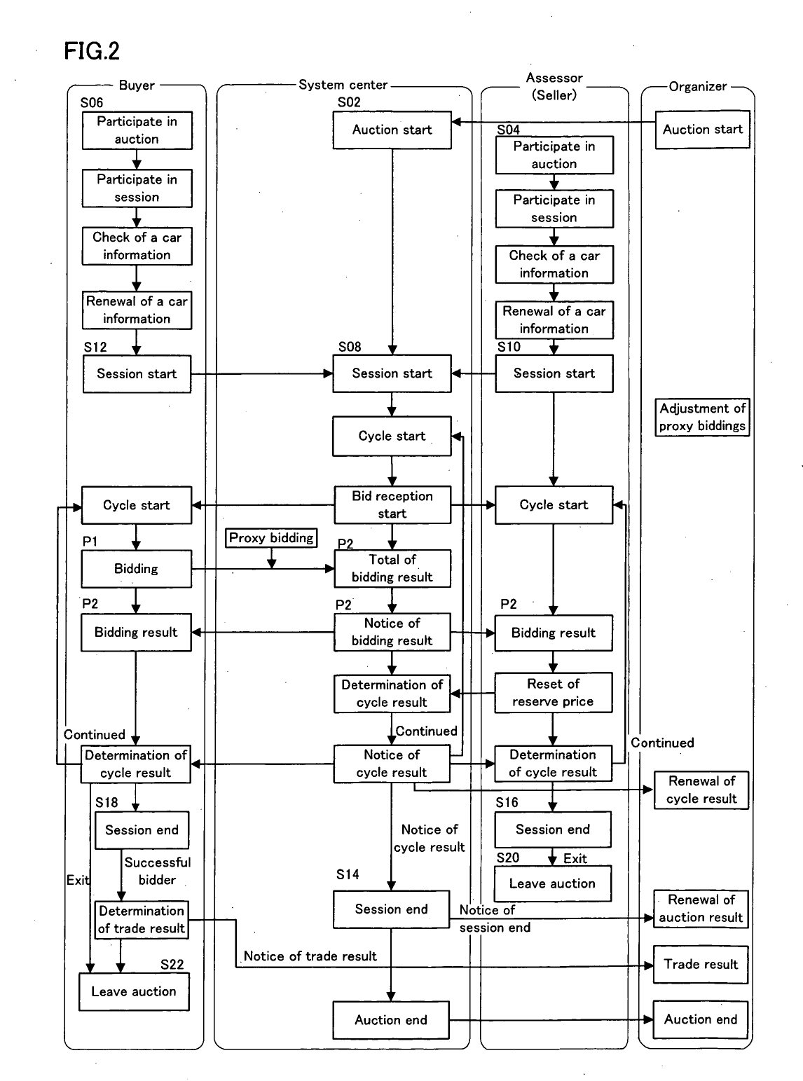

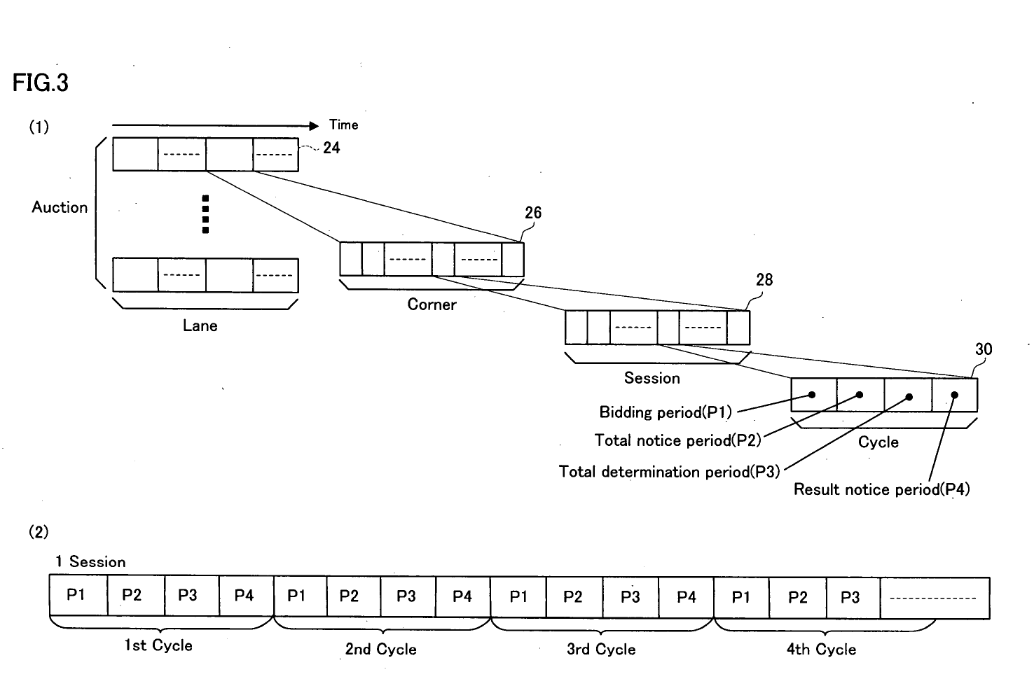

FIG. 2 indicates the workflow of the Internet auction system 2 in this invention. FIG. 3 indicates system-processing flow in this Internet auction system 2. FIG. 3 shows segments of flow by the auction system, which consists of more than one lane (multiple lanes) 24. Auction activities can be processed in parallel in the auction system 2 with more than one lane 24. More specifically, the center system 3 can process multiple lanes at the same time. This means that one buyer (or one assessor) can participate in more than one auction with one buyer equipment 20 (or one assessor equipment 16). For simplicity, a process performed by the center system 3 in one lane will be described hereinafter.

Each lane 24 of FIG. 3 is divided into corners 26 by article category. Conversely, a series of corners 26 constitutes a line 24. Each corner 26 is constituted by more than one session 28. In one session 28, one article is put up for auction where it is successfully bid on or it is aborted. Each session 28 consists of one or more cycles 30, and a cycle 30 is divided into four periods (bidding period or bid entry period P1, bidding status notification period P2, trade determination period P3, and dealing result notification period P4). A later section explains the relationship between each session 28 and its components, cycles 30, and the relationship between each cycle 30 and its components, the four periods.

The lengths of the four periods mentioned above are configurable at the organizer equipment. In this invention, the Internet auction system 2 is assumed to take a few seconds to a few tens of seconds. Therefore, the time length of one cycle will take a few seconds to a few tens of seconds, and the time length of one session will be from several seconds to a few minutes (or a few tens of minutes).

FIG. 2 explains the system flow of the Internet auction system 2. Via the internet 8, buyers, assessors, and sellers can see information on data/time of an auction and articles that will be put up for the auction since this information is open to the public at the center system 3 (This is not indicated in the figure.).

First, an organizer starts an auction (Step S02). Participants participate in the auction with the assessor equipment 16 and the buyer equipment 20 (Step S04 and S06). The center system 3 starts a session after participants sign up for the session (Step S08). At the same time, participants join the session at the assessor equipment 16 and the buyer equipment 20 (Step S10 and S12).

The center system 3 starts a 1st cycle of a session for an article when the session starts. In one cycle, bidding, collection of bidding data and notification of dealing results are taken place under the control of the center system 3. The center system 3 controls cycles in the session to be repeated until the article is successfully bid on or the dealing is aborted. More specifically, the center system 3 determines the bidding, and notifies each buyer equipment 20 and assessor 3 equipment 16 of the result of the bidding. At the buyer equipment 20, buyers enter bids, referring to dealing results from the center system 3. Assessors can control an auction with “reserve price modification” in real-time (it is explained later.)

After the session for the article is finished (Step S14, S16, and S18), buyers and organizer leave the auction (Step S20 and S22). Otherwise, they can stay and continue with the next session.

When an auction (including all of its tasks) in the center system 2 is completed, it is notified to the organizer equipment 12.

Although not shown, an organizer can input a cancellation command to the organizer equipment 12 which is sent to the center system 3 so as to cancel an awaiting session before that session starts or when that session is under way. This enables an organizer to interrupt auctions for unpredictable reasons.

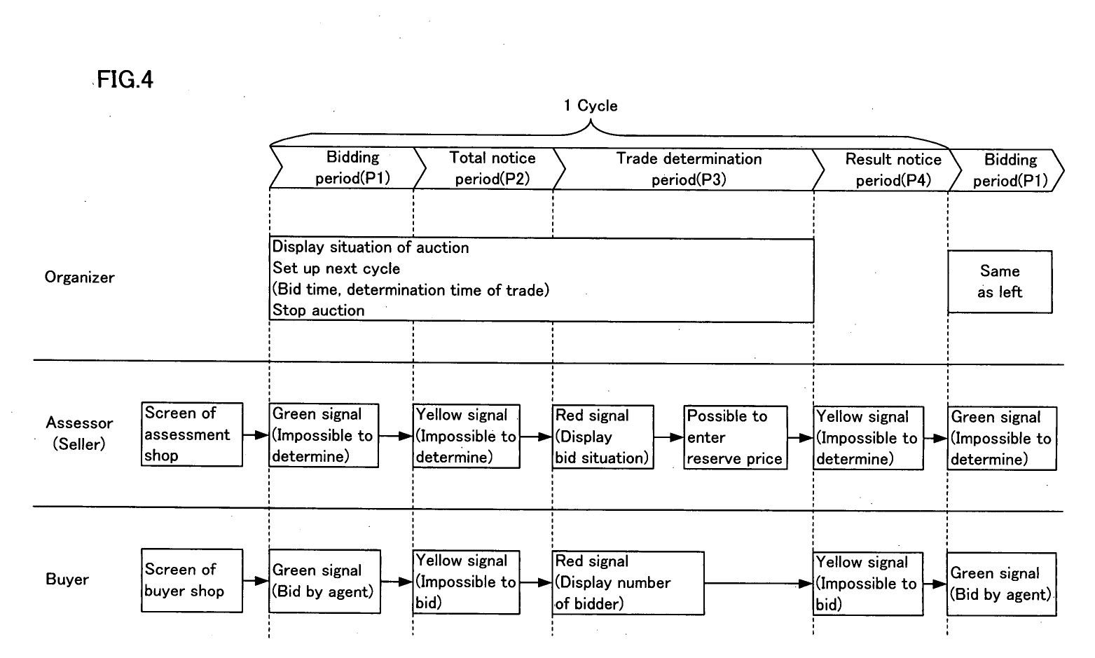

FIG. 4 shows a detailed flow of the cycle 30 (one cycle). As FIG. 4 shows, one cycle consists of four continuous periods (the sum period of the four periods or time length of one cycle from the starting point to the end point of the cycle being claimed “first predetermined period”):

Bidding (bid entry) period P1 (which is claimed “second predetermined time shorter than the first predetermined period”)

Bidding status notification period P2

Trade determination period P3

Dealing result notice period P4

The center system 3 stores the four periods P1, P2, P3, P4 and the sum period in the storage unit 3a.

As shown in FIG. 4, the assessor screen and the buyer screen are displayed in the assessor equipment 16 and the buyer equipment 20. When a cycle starts and the “bidding period P1 “begins buyers can enter bids from the buyer equipment 20 (refer to FIG. 2; P1). At this time, there is no input operation of data from the assessor equipment 16.

Next, in the “bidding status notification period P2,” the center system 3 collects entered bids and then controls to display the bidding status on the screens of the assessors' equipment 16 and the buyers' equipment 20 (refer to FIG. 2; P2).

In the “trade determination period P3,” based on the result of “bidding status notification period P2,” the assessor can execute “reserve price modification” and send a request or command to sell the article with the highest price among bid prices entered by buyers at that cycle. This means, when certain conditions are satisfied, the assessor (or seller) can show its decision to sell the article, by looking at the status of the auction on the screen even if the preset reserve (desired) price is not reached. “Reserve price modification” is explained in a later section.

In the “dealing result notification period P4,” the center system 3 controls to show the result of the “bidding status notification period P2” and the “trade determination period P3,” as well as the session status below:
Whether the article was successfully bid on or the auction was abortive.
Whether the auction continues (and starts the next cycle in the same session).

If the dealing continues, the next “bidding period P1” begins.

The organizer is in charge of monitoring and management of the auction while cycles are operated (shown in FIG. 4). The organizer performs the operation below:
Provide status information of the auction
Decide conditions (such as length of bidding period and length of dealing determination period)
Suspend the auction when it is necessary.

FIG. 5 is an example of a screen 32 on the buyer equipment 20 in the “bidding period P1.” Note that each of the organizer equipment 12 and the assessor equipment 16 has a screen 20. The left side of the screen 32 of FIG. 5 is a first article information field 36, including a photo image 34. The lower right part of the screen 32 is a second article information field 38. The upper right part of the screen 32 is an input area 40 (“input unit”). First, each buyer can enter a bid on the input area 40. Second, the center system 3 controls to show the status of the bidding on the assessor equipment 16 and the buyer equipment 20. Then the “reserve price modification” is input from the assessor equipment 16 and the session status is shown on the assessor equipment 16.

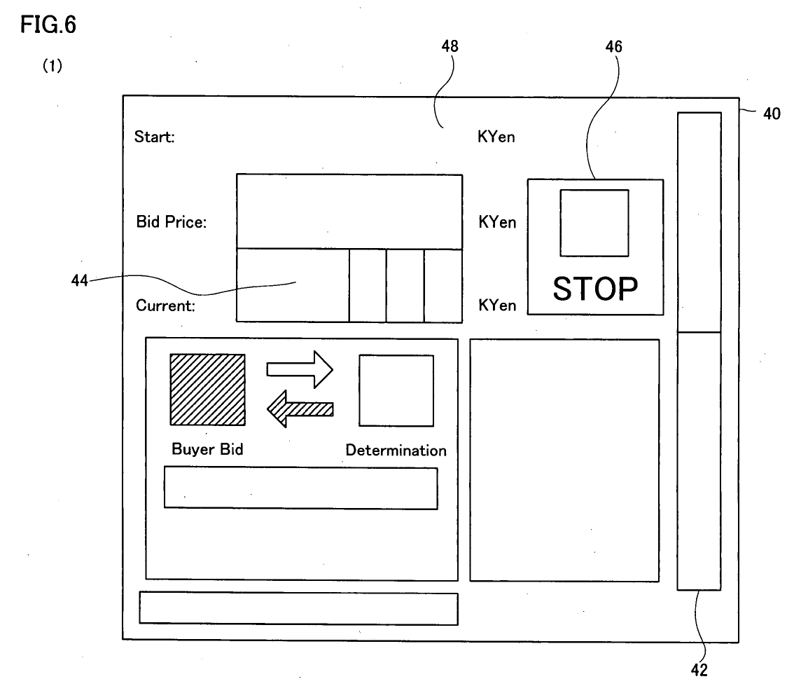

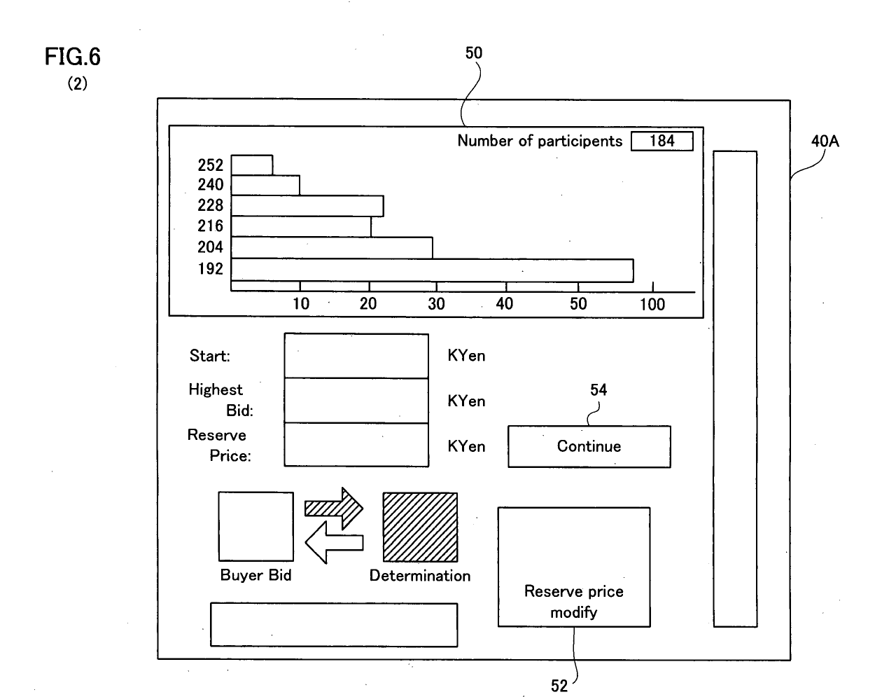

FIG. 6 (1) shows the input area 40 of the buyer equipment 20 in the “bidding period P1.” The assessor presets “ceiling price” for each cycle in advance. The assessor (or seller) can set a starting price 48 before the auction starts. If this is not the first cycle (second or later cycle), then the highest price (that the buyers entered) in the last cycle is the starting price.

In the course of this process and a later-described process which the center system 3 performs after the dealing result notice period P4, the buyer equipment 20 receives, from the center system 3, data at the starting point of the bidding period P1, the time length data (predetermined) of the bidding period P1 (“second predetermined time”), the starting price data and the ceiling price. Furthermore, the center system 3 relates the set of the starting price and the ceiling price for each bidding period (i.e. each immediately preceding bidding period) to the each bidding period, and stores these correlated starting price, ceiling price and bidding period (i.e. immediately preceding bidding period) in the storage unit 3a. Here, the “immediately preceding bidding period” normally refers to a bidding period in each current cycle of a session.

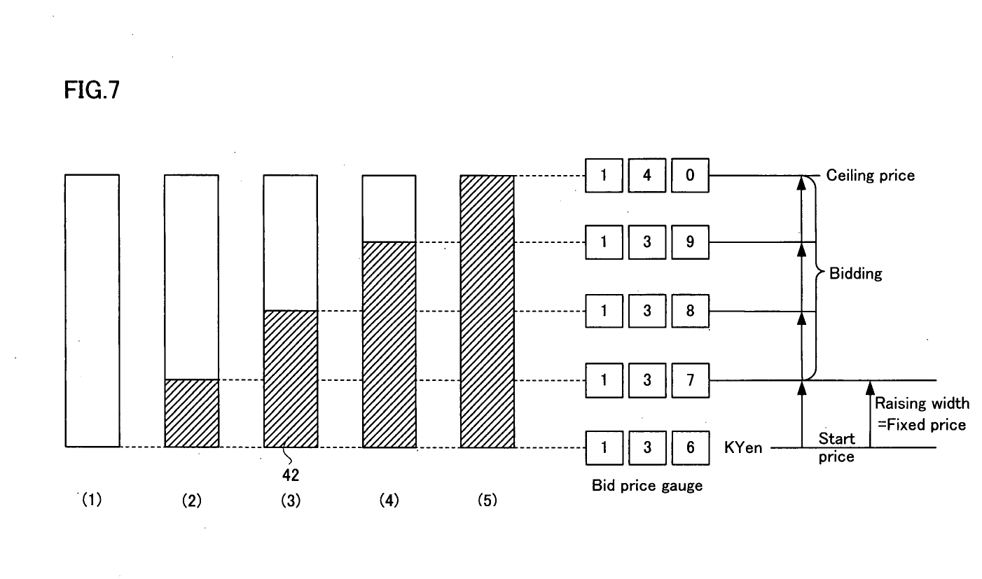

A time indicator 42 is provided on the input area 40 of the screen of the buyer equipment 20 as shown in FIG. 6 (1). The time indicator 42 has a colored bar that rises or gradually increases from the bottom to the top as time elapses as shown in FIG. 7, bars (1), (2), (3), (4), and (5). As already described in the previous section, the organizer sets the length of time it takes for bar to reach the top of the gauge from the bottom (namely the length of the bidding period) of the organizer equipment 12. At the same time with the rise of the colored bar, the price on the bid price indicator 44 rises or gradually increases from “the starting price” to “the ceiling price” and keeps pace with the time indicator 42. FIG. 7 is a schematic bar graph with five bars corresponding to five bid prices showing progress of the time indicator 42 and the bid price indicator 44. The example in FIG. 7 shows an example where “starting price” is “1,360,000 yen” and “ceiling price” is “1,400,000 yen.”

Buyers can enter their bid prices by observing the time indicator 42 and the bid price indicator 44. A buyer clicks on a buyer bid button 46 on the input area 40, at the moment the price indicator 42 points to the price it wants to bid, to enter or input the bid price. The auction system 2 is set such that the entered data (bid price) is automatically sent or transmitted to the center system 3 via the Internet 8. Here the buyer can click on the bid button 46 only from the time the bid price indicator points to the next value of the starting price (namely in the case of FIG. 7, the buyer can start bidding from the price 137,000). The auction system 2 is preferably designed such that the buyer can enter bids as many as it wants at the buyer equipment 20 in the same cycle. In this case, the center system 3 determines that the entered bid is valid and ignores earlier bids in the same cycle.

FIG. 6 (2) shows an input area 40A on the screen of both of the organizer equipment 12 and the assessor equipment 16 during the “bidding status notification period P2” and the “trade determination period P3.” A chart 50 shows the relationship between bid prices and the number of bid entries. The assessor (seller) can make a determination based on the chart 50, and can click on a Reserve price modify button 52 or “Continue (cycle) button “a (Cycle) Continue button 54 in the input area 40A based on the determination.

The center system 3 (“fourth computer”) makes determinations as to the following and controls to display the results of the determinations on all the terminal equipment in the “dealing result notification period P4”:
Whether the article was successfully bid on or the auction was abortive.
Whether the auction continues (and goes on to the next cycle) or not.

If the auction continues, the center system 3 controls to display the following information on the terminal equipment:
The result of the last cycle
Conditions of the next cycle (such as next starting price and next ceiling price for the next cycle)

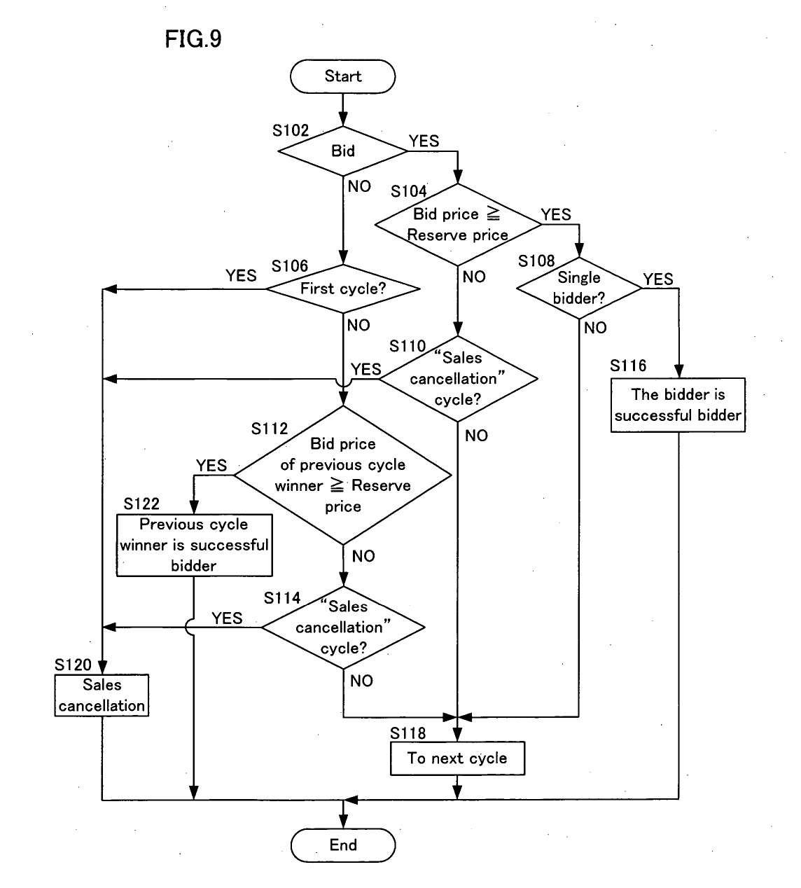

FIG. 9 is a flow chart of a determination process which the center system 3 performs in the “dealing result notification period P4”:
Whether the article was successfully bid on or the auction was abortive.
Whether the auction continues (and goes onto the next cycle).

This flow chart is designed on the assumption that no “reserve price modification” is executed on the assessor equipment 16 in the “trade determination period P3.” The “reserve price modification” is explained in detail later.

FIG. 9—Step S102:

The center system 3 checks whether there has been any bid entry in the current cycle (in an immediately preceding bidding period). If YES, the process goes to Step S104, if not, it goes to Step S106.

Step S104:

The center system 3 checks whether the highest price in all the bid prices is equal to or higher than the “reserve price.” If the center system 3 determines YES in Step S104 and that only one buyer (bidder) enters the current cycle (YES in Step S108), then the center system 3 determines that the bid price of the single buyer (bidder) is a single bid price, and that this single buyer is the successful bidder, so that the center system 3 closes the auction (session) (Step S116). If the center system 3 determines YES in Step S104 and that there is more than one buyer (NO in Step S108), the center system 3 determines that bid prices may rise, so that the center system 3 starts the next cycle (Step S118).

In this manner, according to the present embodiment and hence the present invention, the bidding is automatically repeated a predetermined number of times until there is one bid left (or until abortion of the bidding or trade).

At Step S104, if the center system 3 determines that there is no bid equal to or over the “reserve price,” the center system 3 needs to determine if this cycle is a “sales cancellation cycle” (i.e. last cycle in the maximum number of allowed cycles) such as to abort the auction when no bid reaches the reserve price (Step S110). No bid may possibly reach the reserve price and be successful even over a number of cycles e.g. when the reserve price is too high. The auction system 2 is designed such that the organizer can set the “maximum number of cycles”, over which to abort the auction, so as to avoid repeating cycles in a session which is difficult to be successful. For instance, if the “maximum number of cycles” is set to “4,” the center system 3 determines in Step 110 whether the current cycle is the 4th one or not, namely whether the current cycle is a sales cancellation cycle or not. If the center system 3 determines YES in Step S110, the center system 3 determines the auction to be aborted and ends the session of the article for auction (Step 120). If NO in Step S110, the center system 3 starts the next cycle (Step 118).

Step S106:

The steps from this step will be processed if there is no bid entry at the current cycle. The center system 3 determines in Step 106 if the current cycle is the first one or not. If it is the first cycle (YES in Step S106), the center system 3 determines that there is no buyer willing to buy the article so that the center system 3 cancels or aborts the cycle and auction for the article (sales cancellation) (S120). If NO in Step 106, the process goes to Step S112.

Step S112:

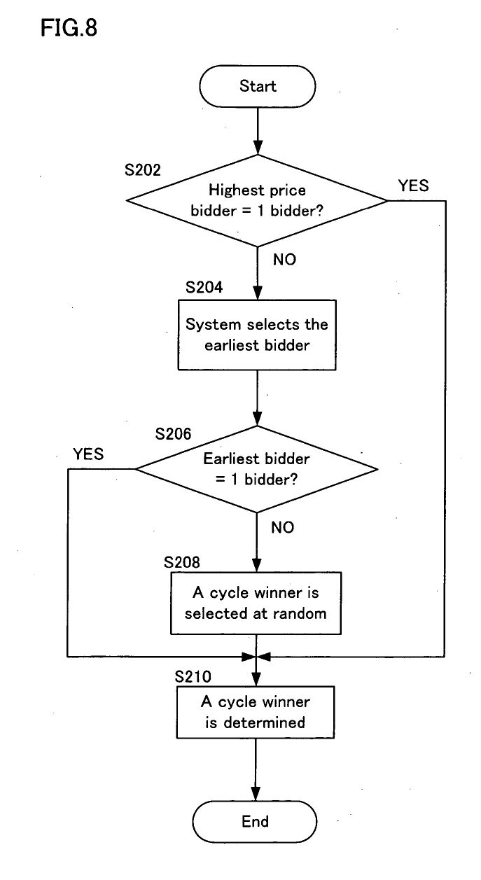

The center system 3 determines if the cycle winner (refer to FIG. 8) of the last cycle bid a price equal to or higher than (i.e. above the reserve price. The “cycle winner ” is a buyer or bidder who enters the highest bid price in a cycle. The details are explained with FIG. 8 later.

At the step S112, if the center system 3 determines that “the bid price of the cycle winner was equal to or over the reserve price in the last cycle” (YES in Step S112), the center system 3 determines that the last cycle winner successfully bid (Step S122) so that the center system 3 ends the cycle and the auction. If NO in Step 112, the process goes to Step S114.

At step S114, the center system 3 determines if this the current cycle is a “sales cancellation cycle” such as to abort the auction when no bid reaches the reserve price (Step S114). If the center system 3 determines YES in Step S114, the center system 3 determines the cycle and the auction to be aborted and ends the auction for the article (Step S120). If NO in Step S 114, the process goes onto the next cycle (Step S118).

After these processes, the flow chart in the FIG. 9 ends.

The logic or process for determining a “cycle winner” described above (in Step S112) will be described below with reference to FIG. 8 showing an example of a flow of the determination logic of the “cycle winner”.

Step S202:

The center system 3 determines if there is one or more than one buyer (bidder) who enters the highest bid price. If the center system 3 determines that there is only one buyer (YES in S202), the process goes to Step S210. If more than one (NO in S202), the process goes to Step S204.

Step S204:

When the center system 3 determines that there is more than one buyer (bidder) having entered the highest bid price, the center system 3 selects a buyer having entered it earliest. If the center system 3 determines that it the bid is a “proxy bid” as will be described later, the center system 3 determines the bid to have been entered at the time of the entry of the “proxy bid”.

Step S206:

The center system 3 determines if there is only one buyer having entered the highest bid price earliest. If only one (YES in S206), the process goes to Step S210. If more than one or multiple buyers (NO in S206), the process goes to Step S208.

Step S208:

The center system 3 selects one buyer at random from buyers (bidders) having entered the highest bid price earliest among the multiple buyers.

Step S210:

The center system 3 determines the selected (left) one bidder as a cycle winner. Then, the center system 3 ends the determination process of a cycle winner.

Participants of the auction can see information on the cycle winner, a ranking chart and summary data on the respective input areas of the screens of the organizer equipment 12, assessor equipment 16 and buyer equipment 20, which the center system 3 controls to display. Therefore, the cycle winner, in particular, can decide on the next bidding by considering that information.

Optionally, the center system 3 and the buyer equipment 20 can be designed to provide a feature that the buyer having earliest entered the highest bid price, which is higher than the reserve price, can see a “you have the right” notification on the input area 40 of the screen 32 on the buyer equipment 20 of such buyer.

<<Further Embodiment for Bid Entry>>

In the description above, a bid price is entered at the buyer equipment 20, which is connected to the center system 3 through the Internet 8 in real-time after each session starts. This further embodiment, on the other hand, allows buyers to enter, or more specifically pre-enter, bids before the session starts if certain conditions are satisfied. This further embodiment is effective e.g. when buyers know that they cannot access the Internet auction system 2 during the auction for some reason. In the present specification, this bid entry is also referred to as “proxy bid or proxy bidding”, which can also be referred to as pre-entry bid as described above.

A proxy bid is entered at the buyer equipment 20 and transmitted to the center system 3 and the organizer equipment 12 along with information e.g. on the identification of the buyer, entry date and time, target article, and ceiling (cap or upper limit) price.

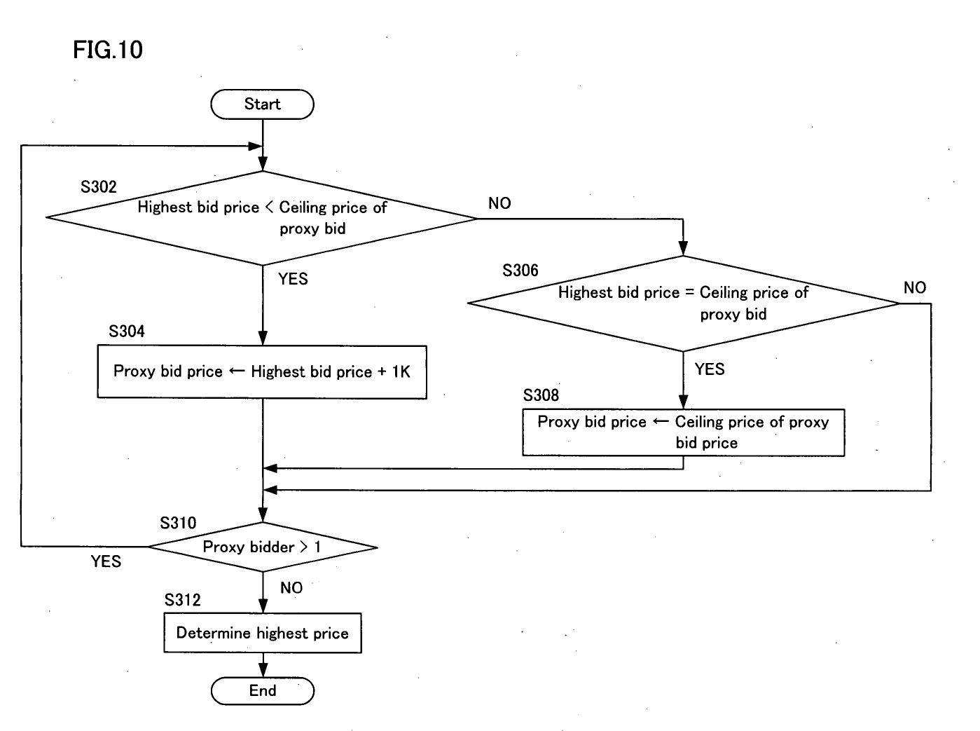

FIG. 10 is an example of a logic (process) flow of the proxy bid price determination and the determination of the highest bid price in the current cycle in the “bidding period P1” that are determined by the center system 3.

Here, it is assumed that before this flow starts, the center system 3 has already determined the highest bid price based on entries from buyers after the auction starts (hereafter referred to as real-time highest bid price. If no buyer has participated after the start of the auction the center system 3 determines a winning bidder (from the proxy bidder or bidders) and a winning bid price based on conditions preset e.g. by the auction organizer by providing data of the winning (buyer) bidder with winning bidder data.

Step S302:

The center system 3 determines if the real-time highest bid price is lower than “ceiling bid price of the proxy bid.” If lower (YES in S302), the process goes to Step S304, while if equal or higher (NO in S302), the process goes to Step S306.

Step S304:

The center system 3 adds a minimum bid price unit (e.g. 1 K yen in the case of FIG. 7) to the real-time highest bid price, and treats the sum price as a bid price of the proxy bidder (bidders) in the current cycle. Then the progress goes to Step S310.

Step S306:

The center system 3 determines if the real-time highest bid price is equal to the “ceiling price” of the proxy bid. If YES in S306, the process goes to Step S308, and the center system 3 sets the “ceiling price” of the proxy bid as a bid price of the proxy bidder (bidders) in the current cycle, then going to Step S310. If NO in S306 (i.e. higher), the progress goes to Step S310.

Step S310:

The center system 3 determines whether the number of proxy bidders is more than one. If YES in S310, the center system 3 repeats the process from Step S302 for such other proxy bidder, and determines a bid price in the cycle for such other proxy bidder. After the determination of all the proxy bidders, the progress goes to Step S312.

Step S312:

The center system 3 determines the highest bid price among all the proxy bidders.

In this manner, the proxy bid price determination and the determination of the highest bid price in the current cycle that are determined by the center system 3 are completed.

For the remaining process in the current cycle (in the bidding status notification period P2, trade determination period P3, and dealing result notification period P4) following the process described above, the center system 3 uses the proxy bid price and the highest bid price determined in “the bidding period P1”. Other conditions for the remaining process are the same as described above.

<<Further Embodiment for “Reserve Price Modification”>>

In the description above, an assessor or a seller registers “reserve price (primary reserve price)” at the assessor equipment 16 before auction session starts. This further embodiment describes an auction system 2 that enables each assessor and seller to enter a secondary “reserve price” in the “trade determination period P3” in an optical cycle in the session. By entering the secondary reserve price, each assessor and seller can decide to sell at a price that is lower than the primary reserve price but is higher than for at least equal to) the bid price that the bidding status indicates by considering the bidding status of the center system 3 shown in the “bidding status notification period P2”.

For this purpose as well, the storage unit 3a of the center system 3 can store not only the primary reserve price (prices) and the bid price (prices) entered from the input unit of the buyer equipment 20 and transmitted to the center system 3, but also the secondary reserve price (prices) transmitted from the assessor equipment 16, so that the center system 3 can compare the bid price (prices) with the primary or secondary reserve price (prices).

Assessors and sellers can enter the secondary reserve prices (reserve price modification) on the input area 40A at the assessor equipment 16 in “trade determination period P3.” For instance, on the input area 40A of the screen shown in FIG. 6 (2), each assessor and seller can click on the “reserve price modify button” 52 and execute the reserve price modification.

For example, the assessors and sellers can execute reserve price modification in either one of the following manners:

1) Assessors and sellers can modify the reserve price when the difference between the highest bid price in the current cycle and the reserve (desired) price (primary reserve price) set before the auction is smaller than a “maximum allowable price gap for the reserve price modification” that the organizer sets before the auction. For instance,

In the condition below, assessors and sellers can modify the reserve price.
Reserve price—200,000 yen
Highest bid price—170,000 yen
Maximum allowable price gap for the reserve price modification—40,000 yen
   In the case below, on the other hand, the reserve price modification is not acceptable.
Reserve price—200,000 yen
Highest bid price—155,000 yen
Maximum allowable price gap for the reserve price modification—40,000 yen

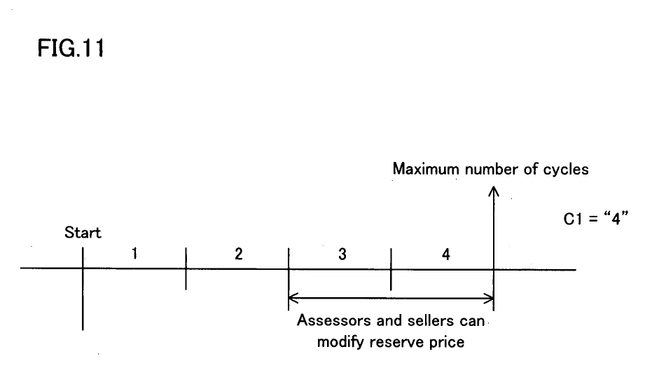

2) An organizer can define “reserve price modification allowed cycles” (i.e. number of cycles in which the reserve price modification is allowed) at the organizer equipment 12 in addition to the “sales cancellation cycle” (i.e. last cycle in the maximum number of allowed cycles). For instance (refer to FIG. 11),
“Maximum number of allowed cycles” is the number of cycles such that when there is no bid higher than the reserve price even in the last one of the cycles, the center system 3 determines that the auction is aborted. This number is defined here as C1. FIG. 11 shows an example when this C1 is 4.
“Reserve price modification enabled allowed cycles” is set as e.g. “2,”

Under these conditions, Assessors and sellers can modify the reserve price in the cycle “C1-1” C1 (i.e. penultimate cycle in the maximum number of allowed cycles) and the cycle “C1” (i.e. last cycle in the maximum number of allowed cycles) when there is a bid in such cycle. That means they can modify in the last two cycles.

3) An assessor can be allowed to modify the reserve price on the assessor equipment 16.

When the reserve price modification is entered, the reserve price is modified (lowered) to the modified (secondary) reserve price at which the auction is performed. Thus, under these conditions, the center system 3 continues the steps in the flow chart of FIG. 9 in the “dealing result notification period P4”:
Whether the article is successfully bid on or not (i.e. aborted);
Whether the auction continues (and goes onto the next cycle in the same session).

As described in the foregoing, the present invention achieves the Internet-based real-time auction. Buyers, assessors and sellers can deal in auctions as they do in traditional auctions since they can continue each auction until there is only one bidder left.

Many articles can be traded in a shorter period because a session for one article can be completed in a few tens of seconds to a few minutes. Furthermore, participants (buyers, assessors and sellers) can deal at more than one lane at the same time, since the center system 3 can process multiple lanes.

In this auction system, dealings are more controllable for assessors and sellers. This means that they can sell goods articles at preferable prices.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

What is claimed is:

1-20. (canceled)

21. A real-time auction system comprising:
a first computer operated by an auction organizer;
a second computer operated by an assessor who exhibits and sells articles;
a plurality of third computers operated by buyers;
a fourth computer in a center for processing;
all of the computers being connected to an online system for receiving and sending data on an auction;
the auction being performed under the control of the fourth computer as follows:
step 1: the buyers bid a price for an article during a first predetermined time period, with the bid information being transmitted to the first computer;
step 2: status of bidding on the article is transmitted to all of the computers over the online system;
step 3: the organizer, the assessor and the buyers confirm the bidding status during a second predetermined time period;
step 4: If the fourth computer determines that there is more than one bid above a reserve price for the article set by the assessor, the fourth computer controls step 1, step 2 and step 3 to be repeated a predetermined number of times until the fourth computer determines that there is one bid left; the one bid being the successful bidder.

22. The real-time auction system according to claim 21, wherein screens of the third computers have a time indicator, a bid price indicator and a bid button; and wherein during the first predetermined time period a gradually increasing price is displayed on the bid price indicator from a starting price to a ceiling price while the time indicator rises at the same time and at the same speed with the price increase.

23. The real-time auction system according to claim 22, wherein the buyers may click on the bid button when the bid price indicator reaches a price the buyers want to bid.

24. The real-time auction system according to claim 23, wherein the buyers may enter a pre-entry bid before the auction opens; the pre-entry bid being entered by the buyers when the auction is open and being treated as a maximum bid price.

25. The read-time auction system according to claim 24, wherein if no bid is equal to or above the reserve price for the article set by the assessor, the assessor can designate the buyer who bids the highest price as the successful bidder on the second computer.

26. The real-time auction system according to claim 25, wherein a first bidder who enters a price that is equal to or above the reserve price for the article set by the assessor can see an indication that the first bidder was the first to enter such a price.

27. The real-time auction system according to claim 26, further including electromagnetic media for storing computer programs used by the first computer, the second computer, the plurality of third computers and the fourth computer.

28. The real-time auction system according to claim 25, wherein a first bidder who enters a price that is equal to or above the reserve price for the article set by the assessor can see an indication that the first bidder was the first to enter such a price.

29. The real-time auction system according to claim 24, wherein if no bid is equal to or above the reserve price for the produce set by the assessor, the assessor can designate the buyer who bids the highest price as the successful bidder on the second computer.

30. The real-time auction system according to claim 24, wherein a first bidder who enters a price that is equal to or above the reserve price for the article set by the assessor can see an indication that the first bidder was the first to enter such a price.

31. The real-time auction system according to claim 23, wherein if no bid is equal to or above the reserve price for the produce set by the assessor, the assessor can designate the buyer who bids the highest price as the successful bidder on the second computer.

32. The real-time auction system claim 23, wherein a first bidder who enters a price that is equal to or above the reserve price for the article set by the assessor can see an indication that the first bidder was the first to enter such a price.

33. The real-time auction system according to claim 22 wherein the buyers may enter a pre-entry bid before the auction opens; the pre-entry bid being entered by the buyers when the auction is open and being treated as a maximum bid price.

34. The real-time auction system according to claim 22, wherein if no bid is equal to or above the reserve price for the produce set by the assessor, the assessor can designate the buyer who bids the highest price as the successful bidder on the second computer.

35. The real-time auction system claim 22, wherein a first bidder who enters a price that is equal to or above the reserve price for the article set by the assessor can see an indication that the first bidder was the first to enter such a price.

36. The real-time auction system according to claim 22, further including electromagnetic media for storing computer programs used by the first computer, the second computer, the plurality of third computers and the fourth computer.

37. The real-time auction system according to claim 21, wherein the buyers may enter a pre-entry bid before the auction opens; the pre-entry bid being entered by the buyers when the auction is open and being treated as a maximum bid price.

38. The real-time auction system according to claim 21, wherein if no bid is equal to or above the reserve price for the produce set by the assessor, the assessor can designate the buyer who bids the highest price as the successful bidder on the second computer.

39. The real-time auction system according to claim 21, wherein a first bidder who enters a price that is equal to or above the reserve price for the article set by the assessor can see an indication that the first bidder was the first to enter such a price.

40. The real-time auction system according to claim 21, further including electromagnetic media for storing computer programs used by the first computer, the second computer, the plurality of third computers and the fourth computer.

41. A real-time auction system having a center system and bidder equipment of bidders that are formed of computers interconnected via internet,
wherein the center system compares a reserve price of an article for auction stored in a predetermined storage unit with one or more of bid prices input and sent from input unit of the bidder equipment so as to determine a winning bidder such that if a single bid price is equal to or higher than the reserve price, the center system determines the bidder of the single bid price as a winning bidder, while if multiple bid prices are equal to or higher than the reserve price, the center system determines the bidder of the highest one of the bid prices as a winning bidder,
wherein the center system stores in the storage unit: a starting price indicating an initial bidding price; a ceiling price indicating an upper limit of bid price to be input by the input unit of the bidder equipment; and the reserve price of the article,
wherein the center system further stores in the storage unit: a first predetermined period of a cycle of auction from a starting point to an end point of the cycle; and a second predetermined period corresponding to a bidding period, which is shorter than the first predetermined period, and
wherein the center system performs:
a cycle starting step for starting and continuously counting a cycle with the first predetermined period including the bidding period;
a first determining step for determining whether or not bid price data, which is transmitted from the bidder equipment and temporarily stored in the storage unit, and which is transmitted between a starting point of the bidding period to an end point of the second predetermined period, contains price data between the starting price and the ceiling price, in which the center system relates a set of the starting price and the ceiling price for an immediately preceding bidding period to the immediately preceding bidding period, and stores the correlated starting price, ceiling price and immediately preceding bidding period in the storage unit;
a second determining step for determining whether or not at least one of the bid price data is equal to or higher than the reserve price if the center system determines, in the first determining step, that the bid price data contains price data between the starting price and the ceiling price;
a third determining step for determining whether or not the bid price data contains a single bid price equal to or higher than the reserve price in the immediately preceding bidding period if the center system determines, in the first determining step, that the bid price data contains price data between the starting price and the ceiling price, and further determines, in the second determining step, that at least one of the bid price data is equal to or higher than the reserve price;
a first repeating step (i) for determining the highest one of the transmitted bid price data to be a next starting price for a next cycle, and storing the next starting price in the storage unit, and further re-performing the cycle starting step, the first determining step, the second determining step and the third determining step after the end of the first predetermined period, and (ii) for repeating the re-performance until the center system determines a winning bidder, if the center system (a) determines, in the first determining step, that the bid price data contains price data between the starting price and the ceiling price, and (b1) determines, in the second determining step, that each of the bid price data is lower than the reserve price, or (b2a) determines, in the second determining step, that at least one of the bid price data is equal to or higher than the reserve price, and (b2b) determines, in the third determining step, that the bid price data contains multiple bid prices equal to or higher than the reserve price in the immediately preceding bidding period; and
a first winning determination step (i) for determining the bidder of the bid price equal to or higher than the reserve price to be a winning bidder by providing data of the winning bidder with winning bidder data, if the center system (a) determines, in the first determining step, that the bid price data contains price data between the starting price and the ceiling price, and (b2a) determines, in the second determining step, that at least one of the bid price data is equal to or higher than the reserve price, and (b2c) further determines, in the third determining step, that the bid price data contains a single bid price equal to or higher than the reserve price in the immediately preceding bidding period.

42. The real-time auction system according to claim 41,
wherein the bidder equipment receives, from the center system, data of the starting price and the ceiling price, and
wherein the bidder equipment further comprises an input display area having:
a price indicator for indicating price which increases from the starting price to the ceiling price in the bidding period; and
a bid button to be clicked for causing the bidder equipment to enter, as a bid price, a price which is displayed on the price indicator at the time of the click.

43. The real-time auction system according to claim 42, wherein the input display area of the bidder equipment further has a time indicator having a length from a bottom to a top for displaying a bar which increases from the bottom to the top in the bidding period with an increase of the price of the price indicator from the starting price to the ceiling price.

44. The real-time auction system according to claim 41, wherein the center system further performs:
a fourth determining step for determining whether or not the bidding period is of a first cycle if the center system determines, in the first determining step, that the bid price data is absence of a bid price between the starting price and the ceiling price; and
a first ending step for ending the process without providing data of any bidder with winning bidder data, if the center system determines, in the fourth determining step, that the bidding period is of the first cycle.

45. The real-time auction system according to claim 41, wherein the center system further performs:
a fifth determining step for determining whether or not the bid price data contains a single bid price equal to or higher than the reserve price, if the center system determines, in the second determining step, that at least one of the bid price data is equal to or higher than the reserve price;
a second repeating step for determining the highest one of the bid price data to be a next starting price for a next cycle, and storing the next starting price in the storage unit, and further re-performing the cycle starting step, the first determining step, the second determining step and the third determining step after the end of the first predetermined period, if the center system determines, in the fifth determining step, that the bid price data contains multiple bid prices equal to or higher than the reserve price; and
a second winning determination step for determining the bidder of one of the bid prices equal to or higher than the reserve price to be a winning bidder in the next cycle by providing data of the winning bidder with winning bidder data.

46. The real-time auction system according to claim 45, wherein the center system further performs: a first transmitting step for transmitting, to a bidder equipment having transmitted the highest one of the bid price data, a message indicating that the center system has received the highest bid price at the time of the transmission from the bidder equipment, if the center system determines, in the fifth determining step, that the bid price data contains multiple bid prices equal to or higher than the reserve price.

47. The real-time auction system according to claim 41,
wherein the center system further performs:
a sixth determining step for determining whether or not the bidding period is of one of the cycles stored in the storage unit, if the center system determines, in the second determining step, that each of the bid price data is lower than the reserve price;
a second ending step for ending the process without providing data of any bidder with winning bidder data, if the center system determines, in the sixth determining step, that the bidding period is of one of the cycles stored in the storage unit; and
a third repeating step for re-performing the cycle starting step, the first determining step, the second determining step and the third determining step after the end of the first predetermined period, if the center system determines, in the sixth determining step, that the bidding period is different from any one of the cycles stored in the storage unit.

48. The real-time auction system according to claim 41, wherein the bidder equipment performs:
a first entering step for entering a proxy bid price for proxy bidding in advance of start of the auction; and
a first bidding transmission step for transmitting the proxy bid price to the center system in advance of the start of the auction, and wherein the center system further performs:
a step of storing, in the storage unit, the proxy bid price received from the bidder equipment in advance of the start of the auction; and
a proxy bid setting step for setting an actual proxy bid price which is a sum of a predetermined price value and the highest one of the bid prices received from other bidder equipment in the bidding period under the condition of using the proxy bid price stored in advance as a ceiling price in each cycle of the auction.

49. The real-time auction system according to claim 41, which further comprises an assessor equipment formed of a computer,
wherein the assessor equipment enters modified data modifying the reserve price, and transmits the modified data to the center system, and
wherein the center system further performs a modifying step for receiving the modified data, modifying the reserve price stored in the storage unit based on the modified data, and re-storing the modified reserve price in the storage unit.

50. The real-time auction system according to claim 41, wherein the first predetermined period is a few seconds to a few tens of seconds.
